(19) United States
(12) Patent Application Publication
(10) Pub. No.: US 2011/0164316 A1
(43) Pub. Date: Jul. 7, 2011

(54) POSITIONING SYSTEM

(75) Inventor: Folkert Kassen, Lahnau-Atzbach (DE)

(73) Assignee: ITK DR. KASSEN GMBH, Lahnau (DE)

(21) Appl. No.: 13/058,517

(22) PCT Filed: Aug. 13, 2009
(86) PCT No.: PCT/EP2009/060480

§ 371 Date: Mar. 7, 2011

(30) Foreign Application Priority Data
Aug. 15, 2008 (DE) 10 2008 037 876.3

(51) Int. Cl. G02B 21/26; B25J 9/02

(52) U.S. Cl. 359/391; 414/749.1

(57) ABSTRACT

The invention relates to a positioning system (10) for positioning an object relative to a technical facility, in particular an observation, measurement or processing system or the like, comprising an object carrier device for receiving the object to be positioned, and a positioning device (12) for positioning the object carrier device, wherein the positioning device has a drive facility for driving the object carrier device, wherein the drive facility has two linear motors (21; 22), arranged such that positioning of the object carrier device in two axes is possible, wherein the positioning device has a measurement facility (23), and wherein the drive facility and the measurement facility are arranged in a manner interposed between a referencing base (26) of the positioning device and the object carrier device.

The invention relates to a positioning system for positioning an object relative to a technical facility, in particular an observation, measurement or processing system or the like, comprising an object carrier device for receiving the object to be positioned, and a positioning device for positioning the object carrier device, wherein the positioning device has a drive facility for driving the object carrier device, wherein the drive facility has two linear motors, arranged such that positioning of the object carrier device is possible in two axes, and wherein the positioning device has a measurement facility.

Positioning systems for positioning objects, which are movable in two axes have been known for some time, and are regularly also referred to as a compound table or XY-table. A compound table has two guides arranged at a right angle to each other, which connect an object carrier device provided for receiving an object to be positioned to a positioning device. Thus, compound tables are also used in microscopy and in measurement systems among other applications, areas where particularly high accuracy requirements apply. An object or sample holder with a sample is then moved using the compound table relative to a microscope objective or a measurement sensor into one or more positions, for observation or measurement. In order to meet the high accuracy requirements, the compound tables known from the prior art generally comprise mechanical actuators, which are in the form of, for example, a spindle drive, a rack and pinion, a Bowden cable or a toothed-belt drive. In order to enable the positioning tasks to be automated, it another known technique is to equip these drives with an electric motor of the rotational motor type. Furthermore, electric-motor based drives, constructed in the form of linear motors are also known, which enable a direct conversion of the motion of a motor into a translational motion.

As well as the movement of the object to be positioned, the determination of its actual position is particularly important, in particular when measurements are to be carried out or specific positions need to be set repeatedly. Normally therefore, the positioning systems described above are equipped with supplementary measurement devices that allow a comparatively accurate determination of position. The measurement devices however are normally constructed in the form of an incremental measurement device, that is, normally after switching on the measurement facility, a zero-point of the measurement system must be visited or a coordinate system of the compound table defined, for referencing the measurement device. Scale units are then counted starting from the zero-point, to determine a position or length as appropriate.

A disadvantage with the positioning systems known from the prior art is the fact that the drive devices are arranged on the compound table as an additional component. In particular the weight of electric motors arranged in the region of an outer edge of the compound table causes an unbalanced weight loading, which leads to displacement of the centre of mass of the compound table. The positioning system supports are thus subject to an unwanted torque loading, which adversely affects a measurement accuracy of the positioning system. This is particularly the case when rotational motors are used that project beyond the compound table to one side, or are underneath the compound table and flange-mounted to it. Rotational motors furthermore have the disadvantage that due to the necessary conversion of a rotational motion into a translational motion, mechanical components generate various noises and vibrations, which can also adversely affect a measurement result.

In particular when a positioning system is used together with a microscope, it is important that the installation height of the positioning system is as low as possible, since the positioning system is intended for use on standard commercial microscopes, which on account of their construction only allow a small amount of space for the arrangement of a positioning system. In transmitted light microscopy in particular, optical components of the microscope must be able to be moved very close up to an object from both sides. It is therefore desirable to construct a compound table to be as thin as possible. The compound tables known from the prior art achieve this by the fact that the drive facility and/or the measurement device are arranged at the edge of a flat, and comparatively thin object carrier device. However, this arrangement leads to the disadvantage of the weight distribution described above, with the corresponding negative effect on the measurement results.

The object addressed by the present invention therefore is to propose a positioning system with increased accuracy, which can be produced by simple means. This problem is solved by means of a positioning system with the features of Claim 1.

The positioning system according to the invention for positioning an object relative to a technical facility, in particular an observation, measurement or processing system or the like, comprises an object carrier device for receiving the object to be positioned, and a positioning device for positioning the object carrier device, wherein the positioning device has a drive facility for driving the object carrier device, wherein the drive facility has two linear motors, arranged such that positioning of the object carrier device is possible in two axes, and wherein the positioning device has a measurement facility, and wherein the drive facility and the measurement facility are arranged to lie between a referencing basis of the positioning device and the object carrier device.

The use of a linear motor in particular as the electric-motor based drive facilitates the construction of a particularly flat positioning system. The referencing basis of the positioning device is immobile relative to the technical facility, or is rigidly fixed to it, wherein the object carrier device with the object can be moved relative to each other in an X-axis and a Y-axis by means of the two linear motors, in the manner of a compound table. Since the drive facility and the measurement device are arranged between the referencing basis of the positioning device and the object carrier device, a weight distribution of the positioning system results in which a centre of mass is arranged comparatively near, relative to a centroid of the object carrier device. This means that an increased measurement accuracy is achieved, since no adverse torque is exerted on the referencing basis of the positioning device, or on the measurement device arranged between the referencing basis of the positioning device and the object carrier device, due to weight forces. Also, the arrangement of the measurement device close to the centre of mass or close to the connection between object carrier device and positioning device favours particularly accurate measurement results, since in comparison to a measurement device arranged on an edge of an object carrier device, torque-induced tilting movements are scarcely amplified over a long distance from the measurement device to a centre of rotation of the object carrier device.

It is particularly advantageous if an absolute value of an unspecified position of the object carrier device relative to the referencing basis of the positioning device can be immediately determined by means of the measurement device. Relative to the known incremental measurement devices, this has the advantage that no zero-point needs to be first visited by the object carrier device, nor any reference point of a coordinate system defined, before an absolute measurement can be calculated by an incremental counting of scale units. In this way the positioning system can deliver an absolute measurement value of a position of an object immediately after it is switched on. In particular when the positioning system is used for the automation of processes a time saving can be obtained, since the need to visit the reference point after the device is switched on is eliminated.

In one embodiment the measurement device can be a magnetic measurement device. Magnetic measurement devices be produced at lower cost can relative to optical measurement devices at comparable accuracy requirements, wherein the assembled size of a magnetic measurement device is smaller compared to an optical measurement device. in particular using glass scales and lenses, and necessary optical paths militate against the miniaturisation of optical measurement devices.

In another embodiment the measurement device can comprise to measurement units. Thus, a first measurement unit can be assigned to an X-axis and a second measurement unit to a Y-axis. By evaluation of a respective position of the measurement unit, an object position cab then be easily determined.

Also, a measurement unit can have a sensor unit and a scale, that can be moved relative to each another. The scale or alternatively the sensor unit can then be connected to the referencing basis of the positioning device, wherein the sensor unit or the scale is connected to the object carrier device, so that during a motion of the object carrier device a relative motion can take place between sensor unit and scale. The measurement unit can then also be particularly easily arranged between the referencing basis and the object carrier device.

If the scale has multiple magnetic tracks, each of the tracks can be scanned by a sensor, wherein one of the tracks can have a precise arrangement of magnetic poles to provide scale units in the form of an incremental scale, and the one or more additional tracks can have phase-shifted magnetic poles relative to the first track, which enable an absolute position to be determined. Therefore, an immediate calculation of an absolute position can be effected without a previous definition of a zero-point. For example, three magnetic tracks can be formed.

Since due to the linear guides and linear motors, the positioning system cannot counter-pose a large resistance to an externally acting force on the positioning system in the direction of an axis, it is particularly advantageous if the object carrier device can be locked by means of a fixing device of the positioning device. A fixing device can then fix the object carrier device relative to the referencing basis of the positioning device during transport or a service interruption, so that unwanted movements of the object carrier device and, if appropriate, damage to the positioning system can be avoided. This means that after a break in operation, an observation or measurement of an object can be continued without interruption, starting from the last position.

In addition, the fixing device can comprise an electromagnet, which can be moved into two stable end positions. In one end position the object carrier device can move freely relative to the referencing basis within the intended limits and in the other end position the moveable components of the positioning device or object carrier device can be fixed with a force fit or positive fit. The electromagnet or fixing device can be simply activated on switching the positioning system off or on by means of a brief voltage pulse, for example.

In one embodiment a control device for controlling the positioning device can be integrated in the positioning device. The control device can for example drive the linear motors and the analyse the measurement device, wherein the control device is preferably matched to the combination of the linear motors with the measurement device. As well as the direct integration of the control device in the positioning device, an arrangement of the control device outside the positioning device is also imaginable, wherein the control device can then be connected to the positioning device via means for exchanging data.

It can also be desirable to position an object in a force-limited manner, in order to prevent damage to the object, to the technical facility or to the positioning system. It is particularly advantageous when a force exerted by the drive facility can be limited by the control device. In the case of linear motors this can be particularly simply effected by limiting a motor current using the control device.

In a further embodiment connection cables of the drive device, the measurement device and the control device can be fixedly arranged. This embodiment can implemented in particular by the integration of the drive facility and the measurement device lying between the referencing basis of the positioning device and the object carrier device. Thus, no cables need be flexibly fed to the drive facility or measurement device, or be movably connected to an object carrier device. The cables cannot then be stressed by repeated movements either and corruption of a measurement result by forces acting in the cables can be avoided.

The positioning device can be constructed in such a way that an analysis of position can be made by the measurement device or by the control device. This means that a direct determination of an absolute position can be easily made in the measurement device itself or in the control device, for example using a piece of software.

In an end position of the object carrier device an object can be handled by the positioning system automatically. Thus in the end position, the object carrier device can be automatically fitted with the object, for example. This can then be particularly simply implemented, if the need to visit a zero-point to determine an incremental measurement value can be eliminated in the relevant end position.

If the object carrier device comprises a microscope table, the positioning system can be advantageously used on a microscope.

If the object carrier device further comprises a sample holder, samples or objects to be observed or to be measured can be easily positioned in a defined position relative to the microscope table of the object carrier device.

If the sample holder is directly coupled to a linear motor of the drive device, the sample holder or the object can be moved along an axis on the microscope table. This simplifies the construction of guides for the positioning device.

In the following the invention is described in more detail by reference to the attached drawings.

They show:

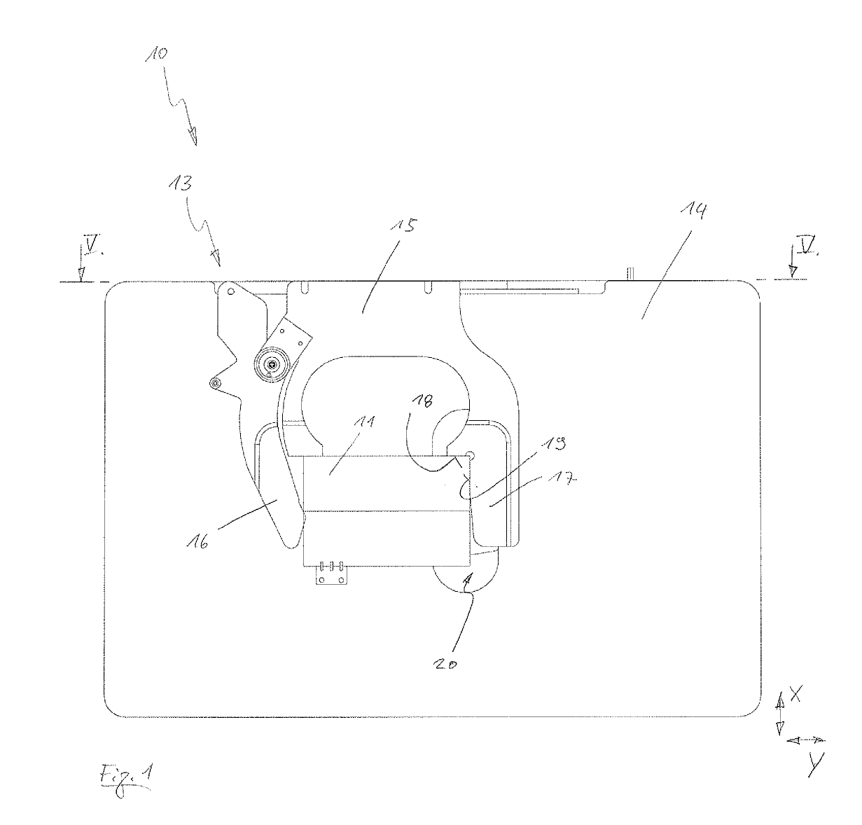

FIG. 1 an embodiment of a positioning system in plan view;

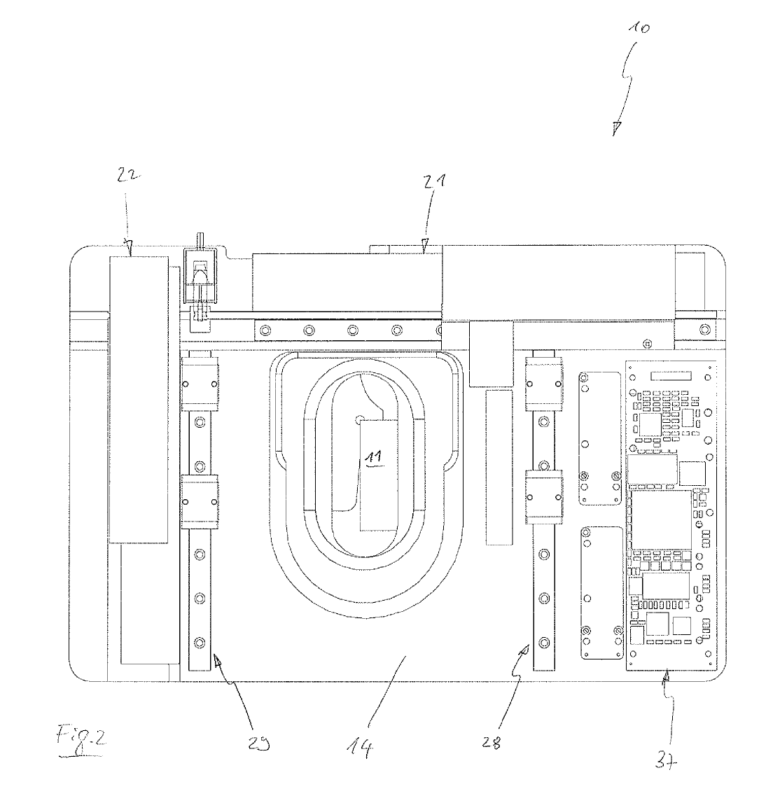

FIG. 2 the positioning system viewed from below without a base plate;

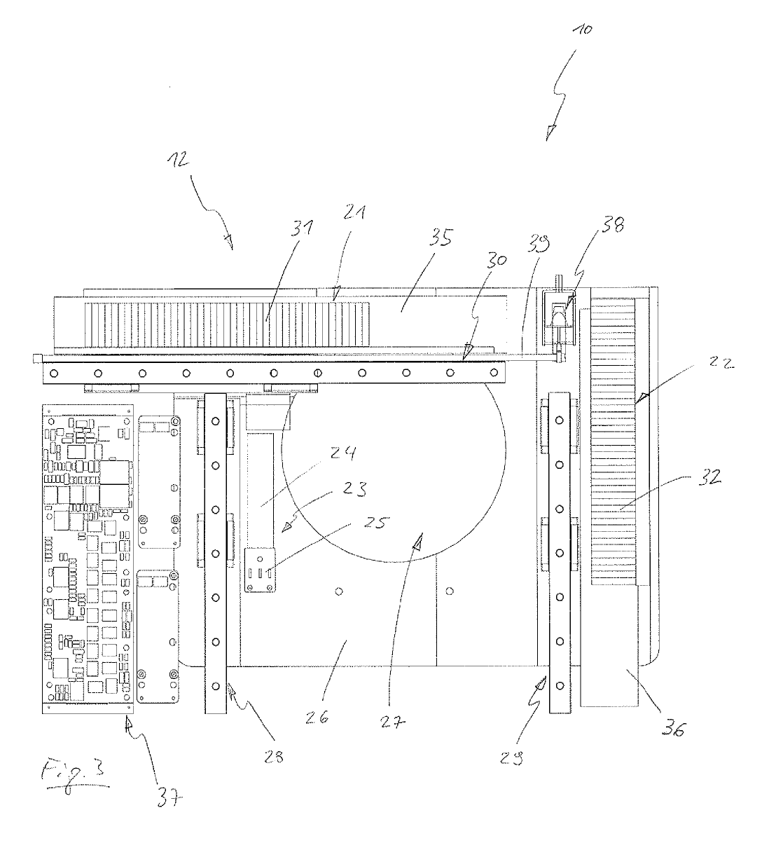

FIG. 3 the positioning system in plan view without an object carrier device;

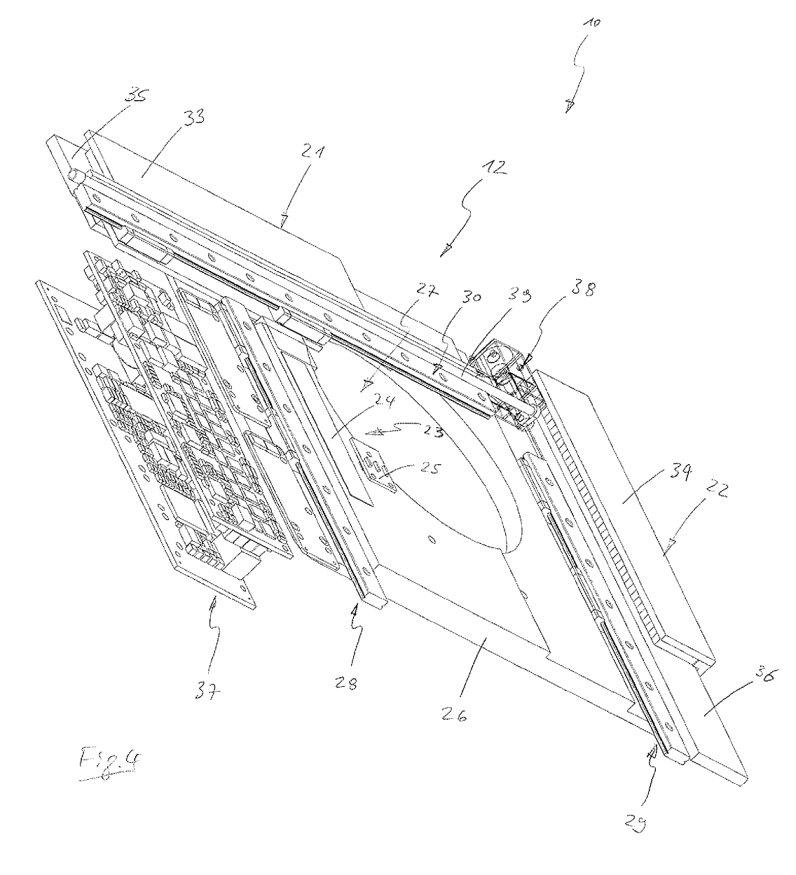

FIG. 4 the positioning system in a perspective view without an object carrier device;

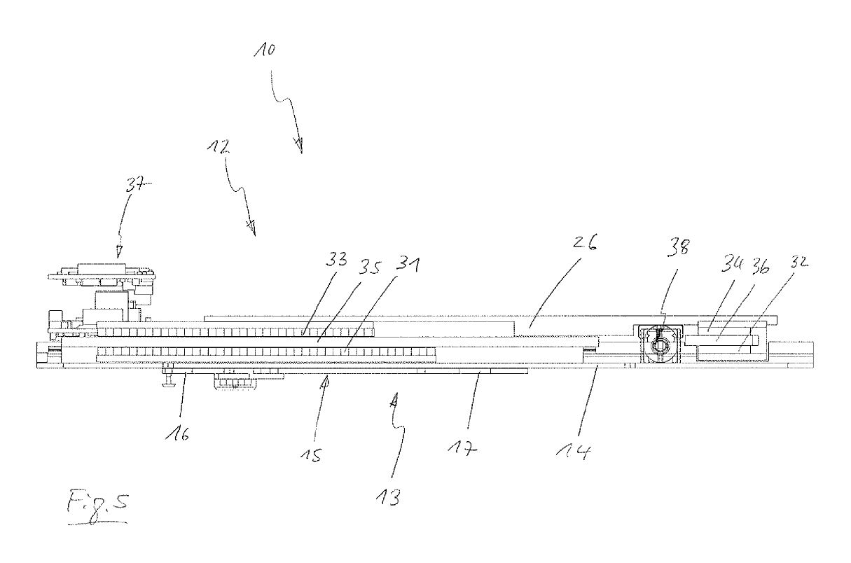

FIG. 5 the positioning system in a side view along a line V-V of FIG. 1.

A comparison of FIGS. 1 to 5 shows a positioning system 10 with a sample carrier 11, which receives an object or sample, not shown here, for possible observation or measurement with a transmitted light microscope. The positioning system 10 is formed from a positioning device and an object carrier device 13. The object carrier device 13 comprises a microscope table 14 and a sample holder 15, wherein the sample holder 15 is constructed in the manner of a pair of tongs with a moveable arm 16 and a fixed arm 17. Two contact surfaces 18 and 19 of the arm 17 form a defined holder for the sample carrier 11. The microscope table 14 is moveable along an X-axis and the sample holder 15 is moveable along a Y-axis at an angle of 90° relative to each other. In addition, in the microscope table 14 a through opening 20 is provided, in order to facilitate illumination or observation of the sample.

The positioning device 12 comprises two linear motors 21 and 22, which together form a drive device. A measurement device 23 is further provided, which is substantially constructed from a magnetic strip 24 and a sensor head 25. A base plate 26 forms a referencing basis of the positioning device 12, wherein the base plate 26 comprises a through opening 27 for illumination or observation devices of a microscope and fixing devices, not shown in further detail, for stationary assembly of the positioning system 10 on the microscope.

In addition, two linear guides 28 and 29 are provided for the connection and longitudinal movement of the microscope table 14 to the positioning device 12, and a linear guide for the connection and longitudinal movement of the sample holder 15. A movement can take place by means of the linear motors 21 and 22, wherein each one of the linear motors 21 and 22 is provided with an intermediate coil 35 or 36, an upper magnet arrangement 31 or 32 and lower magnet arrangements 33 or 34. The measurement signals output by the measurement device 23 are recorded in a control device 37, which is integrated in the positioning system 10. Control of the linear motors 21 and 22 and of a bitable electromagnet 38 is effected by means of the control device 37, which together with a brake rod 39 forms a fixing device. In particular by the integration of the linear motors 21 and 22 together with the measurement device 23 lying between the microscope table 14 and the base plate 26, a particularly compact and flat embodiment of the positioning system 10 is possible, in which by the arrangement of the linear motors 21 and 22 alone a balanced weight distribution is ensured, even in an end position of the object carrier device 13.

1. A positioning system for positioning an object relative to a technical facility, comprising:
an object carrier device to receive the object to be positioned, and
a positioning device to position the object carrier device, wherein the positioning device includes a drive facility to drive the object carrier device, wherein the drive facility includes two linear motors, arranged such that positioning of the object carrier device is possible in two axes, and wherein the positioning device includes a measurement facility,
wherein the drive facility and the measurement device are arranged so that they lie between a referencing basis (26) of the positioning device and the object carrier device.

2. The positioning system according to claim 1, wherein the measurement device can directly determine an absolute value of an unspecified position of the object carrier device relative to the referencing basis of the positioning device.

3. The positioning system according to claim 1, wherein the measurement device includes a magnetic measurement device.

4. The positioning system according to claim 3, wherein the measurement device comprises two measurement units.

5. The positioning system according to claim 4, wherein the measurement unit comprises a sensor unit and a scale, which are moveable relative to each other.

6. The positioning system according to claim 5, wherein the scale comprises a plurality of magnetic tracks.

7. The positioning system according to claim 6, wherein the object carrier device can be locked by a fixing device of the positioning device.

8. The positioning system according to claim 7, wherein the fixing device comprises an electromagnet.

9. The positioning system according to claim 8, wherein the positioning device includes an integrated a control device.

10. The positioning system according to claim 9, wherein the drive facility is to exert a force that can be limited by the control device.

11. The positioning system according to claim 10, wherein connection cables of the drive facility, the measurement device and the control device are fixedly arranged.

12. The positioning system according to claim 11, wherein the positioning device is constructed in such a way that an analysis of position can be affected by the measurement device or by the control device.

13. The positioning system according to claim 12, wherein in one end position of the object carrier device an object can be automatically handled by the positioning system.

14. The positioning system according to claim 13, wherein the object carrier device comprises a microscope table.

15. The positioning system according to claim 14, wherein the object carrier device comprises a sample holder.

16. The positioning system according to claim 15, wherein the sample holder is directly coupled to a linear motor of the drive facility.

17. The positioning system according to claim 1, wherein the positioning device includes a fixing device and the object carrier device is to be selectively locked by the fixing device.
